(19) United States
(12) Patent Application Publication
(10) Pub. No.: US 2023/0114457 A1
(43) Pub. Date: Apr. 13, 2023

(54) PROGRAM, TERMINAL, AND GAME MANAGEMENT APPARATUS

(71) Applicant: BANDAI CO., LTD., Tokyo (JP)

(72) Inventors: Hideto KOTANI, Tokyo (JP); Masahiko SAITO, Tokyo (JP)

(21) Appl. No.: 17/913,195

(22) PCT Filed: Mar. 23, 2021
(86) PCT No.: PCT/JP2021/011835

§ 371 Date: Sep. 21, 2022

(30) Foreign Application Priority Data
Mar. 23, 2020 (JP) 2020-051291

(51) Int. Cl. A63F 13/69; A63F 13/792

(52) U.S. Cl. CPC A63F 13/69; A63F 13/792; A63F 2300/5513

(57) ABSTRACT

A program causes a computer to function as a game element acquisition unit which acquires a game element, a first gift item acquisition unit capable of acquiring a first gift item every time the game element is acquired, and a second gift item acquisition unit capable of acquiring a second gift item when the number of game element acquisition times reaches a predetermined value.

### TECHNICAL FIELD

The present invention relates to a program, a terminal and a game management apparatus.

### BACKGROUND ART

In recent years, games using a smartphone, a mobile phone or the like as a platform, are popular. For example, in such a game, a win or loss of a battle game is determined by using a deck formed by combining game elements such as virtual cards etc. and by using parameters of each of the game elements, which form the deck. In addition, in a system configured to perform such a game, items usable in the game are given to a player by a drawing (for example, Patent Literature 1).

### CITATION LIST

### Patent Literature

Patent Literature 1: Japanese Patent Application Publication No. 2019-42170

### SUMMARY OF INVENTION

### Technical Problem

However, if such items are not provided in a manner to maintain enjoyability of a player, there are some cases where the player loses the enjoyability.

Therefore, it is an object of the present invention to provide a program, a terminal and a game management apparatus capable of realizing a game in which such enjoyability is not lost.

### Solution to Problem

As an aspect of the present invention, a program causes a computer to function as a game element acquisition unit which acquires a game element, a first gift item acquisition unit capable of acquiring a first gift item every time the game element is acquired, and a second gift item acquisition unit capable of acquiring a second gift item when the number of game element acquisition times reaches a predetermined value.

As another aspect of the present invention, a terminal comprises a game element acquisition unit which acquires a game element, a first gift item acquisition unit capable of acquiring a first gift item every time the game element is acquired, and a second gift item acquisition unit capable of acquiring a second gift item when the number of game element acquisition times reaches a predetermined value.

As a still another aspect of the present invention, a terminal comprises a game element acquisition unit which acquires a game element, and a gift item acquisition unit which acquires a gift item at least once until the number of game element acquisition times reaches a predetermined value.

As a yet another aspect of the present invention, a game management apparatus comprises a game element providing unit which provides a game element, a first gift item providing unit capable of providing a first gift item every time the game element is provided, and a second gift item providing unit capable of providing a second gift item when the number of game element provision times reaches a predetermined value.

As a still yet another aspect of the present invention, a game management apparatus comprises a game element providing unit which provides a game element, and a gift item providing unit which provides a gift item at least once until the number of game element provision times reaches a predetermined value.

### Advantageous Effects of Invention

According to the present invention, it is possible to provide a game in which enjoyability is not lost.

### BRIEF DESCRIPTION OF DRAWINGS

FIG. 1 is a diagram illustrating an example of the overall configuration of a game system according to the present embodiment.

FIG. 2 is a diagram illustrating an example of the device configuration of a smartphone, which is an example of a player terminal 1.

FIG. 3 is a diagram illustrating an example of a battle screen for a battle game, which is displayed on a display 11 of the player terminal 1.

FIG. 4 is a block diagram illustrating an example of a functional configuration of the player terminal 1.

FIG. 5 is a diagram illustrating an example of user information data D1.

FIG. 6 is a diagram illustrating an example of in-hand card item data D2.

FIG. 7 is a diagram illustrating an example of card item character data D3.

FIG. 8 is a diagram illustrating an example of deck setting data D4.

FIG. 9 is a diagram illustrating an example of buddy setting data D5 for a player A.

FIG. 10 is a block diagram illustrating an example of a functional configuration of a game server 2.

FIG. 11 is a diagram illustrating an example of user information data G1.

FIG. 12 is a sequence diagram illustrating operations of the player terminal 1 and the game server 2.

FIG. 13 is a flowchart illustrating provision processing performed by the game server 2 (Step 2).

FIG. 14 is a flowchart illustrating acquisition processing performed by the player terminal 1 (Step 3).

FIG. 15 shows an example of a performance screen for a drawing of a first gift item displayed on the player terminal 1.

FIG. 16 shows an example of a performance screen displayed on the player terminal 1 in case where a first gift item is won

FIG. 17 shows an example of a performance screen displayed on the player terminal 1 when a first gift item is not won.

FIG. 18 shows an example of a performance screen displayed on the player terminal 1 when a second gift item is acquired.

### DESCRIPTION OF EMBODIMENTS

### <Embodiment According to the Present Invention>

### [Overall Configuration]

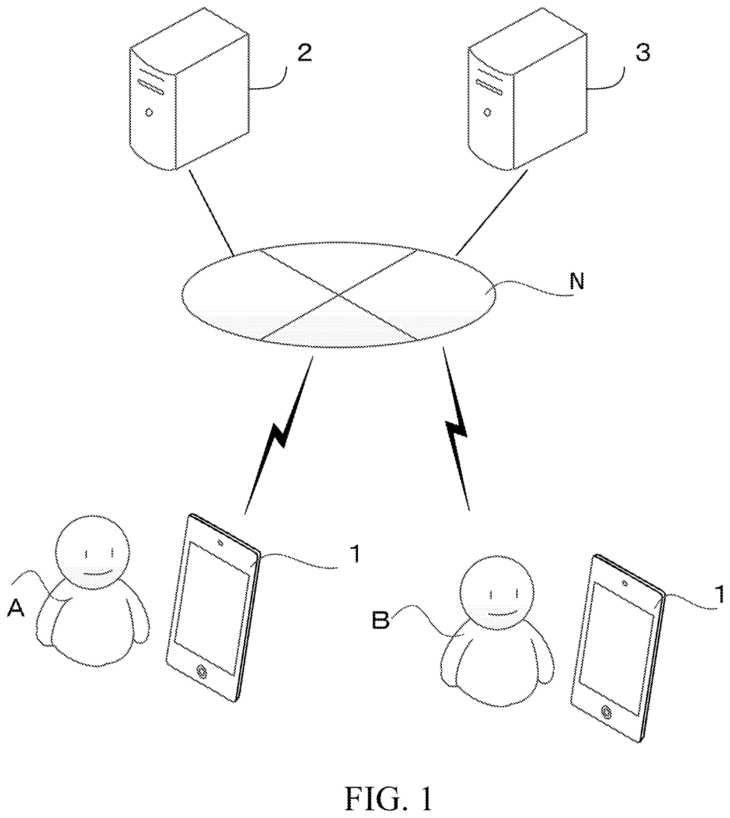

FIG. 1 is a diagram illustrating an example of the overall configuration of a game system according to the present embodiment. As shown in FIG. 1, the game system comprises player terminals 1, which are respectively provided to game players A, B; and a game server 2. The player terminals 1 and the game server 2 are capable of connecting to a communication line N and communicating with each other.

The communication line N represents a communication path capable of data communication. That is, the communication line N includes a communication network, such as a telephone communication network, a cable network, the internet, etc., in addition to a LAN established by a dedicated line (dedicated cable) for direct connection or an Ethernet (registered trademark) and the like. A communication can be performed by any method, and may be either wired or wireless.

The player terminal 1 is a computer capable of running a game program, and can be connected to the communication line N via a wireless communication base station or the like, and can perform data communication with the game server 2. For example, the player terminal 1 may be a smartphone, a mobile phone, a portable game device, a stationary home game device, a business use game device, a personal computer, a tablet computer, and a controller for a stationary home game device or the like. Basically, there are multiple player terminals 1, which are operated by respective players.

The game server 2 is a server system configured by including one or a plurality of server devices and memory devices or the like. The game server 2 provides various services for running a game according to the present embodiment. The game server 2 can perform data management required to run the game, and deliver the game program and data required for performing the game at the player terminal 1 or the like.

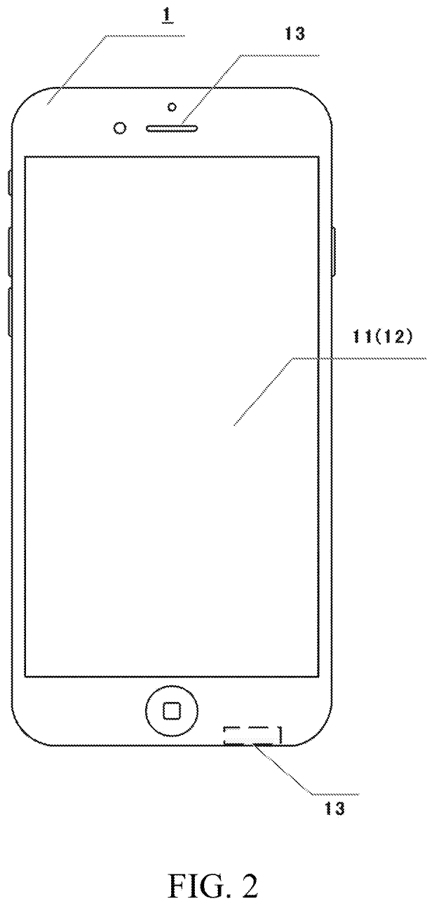

FIG. 2 is a diagram illustrating the device configuration of a smartphone, which is an example of the player terminal 1. As shown in FIG. 2, the player terminal 1 includes a display 11, a touch operation panel 12 integral with the display 11, and a speaker 13. Although not illustrated, a control board, a built-in battery, a power button, and a volume control button and the like are provided in the player terminal 1.

On the control board, various microprocessor(s), such as a CPU, a GPU, a DSP, etc., various IC memories, such as an ASIC, a VRAM, a RAM, a ROM, a wireless communication module for wirelessly communicating with a mobile phone base station and the like are mounted. Further, on the control board, a so-called I/F circuit (interface circuit), such as a driver circuit for the touch operation panel 12, etc., is mounted. These elements mounted on the control board are electrically connected with one another via a bus circuit etc., and are connected so as to be able to read and write data, and transmit and receive signals.

Described blow is an example according to the present embodiment, wherein the above-described system is applied to a battle game that uses game elements owned by a first player A and game elements owned by a second player B, who is an opponent. The game elements used in battle games mainly include two types of game elements.

The first game elements is a character represented by being embodied in an image, or as a virtual or substantial article or the like. The image includes a still image, a video image. An example of the virtual or substantial article is a virtual card displayed on a computer or a substantial card and the like. In addition, the article is not limited to such a card as long as such a game element associated with the article can be identified. For example, the article may be a sculptural object, such as a figure having an appearance of a game element.

In the following description, it is premised that, in a game to be performed, such a first game element is a character whose action is controlled based on an operation to card by the player (including a non-player operated by a computer), and that a corresponding character design (an image exhibiting an exterior appearance of the character) is attached to the card. In addition, the character is not limited thereto, and may be one for identifying some other game element such as an item in the game to be performed or an effect to be invoked etc.

A deck is composed of a predetermined number of first game elements. The predetermined number of first game elements is set as a player's deck. For example, where the first game elements are virtual cards displayed on a computer, the deck is composed of a group of the predetermined number of cards selected by a player. The player selects a desired deck from among decks set by the player, and plays a game by using cards forming the deck.

Further, a second game element different from the first game element is added to the battle game to which the present embodiment is applied.

Although the second game element is a character similar to the first game element, the second game element need not be associated with a virtual or substantial article. The second game element is different from the first game element and is not operated by the player (including a non-player operated by a computer) in a battle of the game. The second game element has a nature of providing the player with operation assistance information, which is information related to a progress of the game at least in a phase where the player can perform an operation.

In other words, it can be said that the second game element provides the operation assistance information autonomously or voluntarily in the game, unlike the first game element who's action is controlled based on an operation of the player (including a non-player operated by a computer).

The operation assistance information may be any type of information as long as it relates to a progress of the game, for example, information of an operation method, information related to selection and actions of first game elements, (advice information such as card selection, cards of the opponent in the battle who is a target of attack and so on), and information, which turns progress of the game in favor (advice information, such as presentation of a card type, which provides advantageous effects to the battle result of the game) or the like.

Further, the second game element uses the first game elements the player owns, in the game. Use of the first game element includes a selection of the first game element and a determination of an action thereof in the game. When the first game elements are, for example, cards, the second game element autonomously or voluntarily determines selection of a card the player owns or an action thereof, in a battle of the game. In other words, as in a function of a non-player operated by a computer, the second game element performs operations similar to selection of a first game element or determination of an action thereof, which is performed by the player. Here, although a conventional non-player is operated by the computer instead of a human player, the second game element exists separately and independently from the human player, and differs therefrom in that the second game element uses the first game elements the player owns.

Each second game element has such character information. This character information is attribute information of the second game element. The character information affects the autonomous or voluntary actions of the second game element (use of the first game element) etc. In other words, the character information is an ability of the second game element, so that the autonomous or voluntary actions of the second game element (providing operation assistance information and use of the first game elements) differ in accordance with the differences in ability. This character information of the obtained second game elements differ from one another. The character information changes in accordance with progress of the game etc. The character information can have two or more parameters. For example, in the present embodiment, the character information includes a parameter which changes in accordance with an empirical value obtained from results of games played by the player (hereinafter refer to as a level); a parameter which changes in accordance with use frequency of the first game elements the player used (hereinafter refer to as a card comprehension level); a parameter which changes in accordance with a use ratio of each of kinds of the first game elements the player used (hereinafter refer to as personality); and a parameter which changes in accordance with achievement of a predetermined event by the player (hereinafter referred to as synchronizing level). In addition, as described below, the synchronizing level may change in accordance with an empirical value obtained with a progress of the game performed by the second game element in case where the second game element performs the battle.

The number of the second game elements may be two or more, and each second game element may have different character information at an initial stage. And the player may select a desired second game elements from a plurality of second game elements whose character information is different from each other.

The autonomous or voluntary action performed by the second game element is performed by an AI function included in the game server 2. This AI function can be realized by a learning model obtained by performing machine learning which uses, as training data, details of progress and results etc. of many battle games. Although a deep learning (deep machine learning), a reinforcement learning, or a combination thereof may be a typical machine learning, it is not limited thereto. In the learning model, an action, which differs depending on the character information of the second game elements, can be output. As a way to realize this, for example, there is a learning model etc., in which the higher the character information level of the second game element is, the more appropriate solution can be obtained in a certain situation by, for example, making the search time for the optimal solution longer as the character information level is higher.

The above-described second game element may be called a buddy in a description below.

The first game element and the second game element are mainly used in battles. In the present embodiment, in addition to the first game element and the second game element, there are a game element, which can be exchanged for the first game element or the second game element; a game element, which gives an effect to the first game element and the second game element; and a game element, which changes the appearance of the first game element and the second game element and the like. Such a game element, which is not used in battles basically, are referred to as an item. The items are mainly provided by a game administration side.

The item is, for example, in-game currency for acquiring the first game elements or the second game elements, a ticket which is exchangeable for the first game elements or the second game elements, a ticket which makes the appearance (expression form) of the first game element or the second game element changeable, or the like. The item can be the first game element or the second game element. In the description below, among the items, an item for which a cost is not required, and which is given to the player as a gift from the game administration side, may be referred to as a gift item.

### [Outline Of Game]

Next, to help understanding of the present embodiment, an overview of a game will be described by using display screens displayed on a display 11 of a player terminal 1.

In a game according to the present embodiment, virtual game cards, which are game objects (first game elements, in each of which a character is embodied, and which is hereinafter simply referred to as “cards”), are used. Two or more kinds of cards are prepared, and are distinguished from each other by combinations of an ability of a character, rarity, an attribute (color), a numeral and the like, which are associated with each card. As the ability of the character, for example, ability parameter values such as a level, an attack power, and HP (hit point), etc. used in a match-up play (a battle) against a battle opponent, such as an enemy character controlled by a computer, or another player, etc., are predetermined.

A minimum number of cards required in the match-up play (battle) is given when an account is registered. Further, the cards can be acquired during a game, or the cards can be acquired by purchasing them as charge items or by a drawing called Gacha. In addition, such a card can be acquired by obtaining a substantial game card (hereinafter referred to as a “real card”) and completing a registration process to make the obtained real card usable in the game. Specifically, when the player A or B registers the real card, the player can acquire a card having a card kind which corresponds to the real card.

The player A then composes a deck by selecting a predetermined number of cards (for example, 40 cards) from among cards owned by the player, and challenges to the match-up play (a battle) using the deck. In the match-up play (battle) using the deck, a win or loss of the battle against an opponent is determined by using an ability parameter value of a character defined in each of the cards forming the deck (deck cards) and a setting value of the attribute of the card.

When starting the game, the players A and B complete registration of their accounts. The player selects a desired second game element (hereinafter referred to as a buddy) from among two or more second game elements which are presented by the player terminal 1 at the time when the players register their accounts so that the buddy forming a group together with each of the player A and B is set. There is a possibility that a play style of the game changes later on, due to a difference in the ability and character of the selected buddy. And the players A and B respectively organize their decks by selecting a predetermined number of cards (for example, 40 cards) from among cards respectively owned by them. The deck can be organized from a deck organization menu, which is presented as a result of touching one on the card menu on a home screen or the like. The match-up play (battle) is started by an operation for selection of a battle menu from the home screen displayed after login.

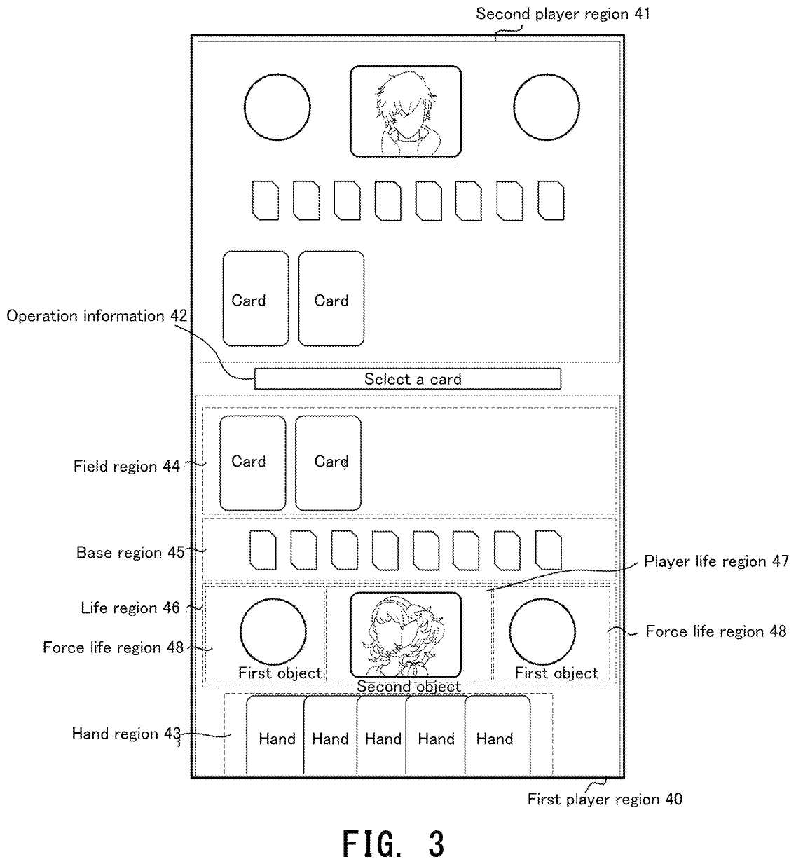

FIG. 3 is a diagram illustrating an example of a battle screen for a battle game displayed on the display 11 of the player terminal 1. The battle screen displayed on the display 11 includes a first player region 40 which is a region for the own player and a second player region 41 which is a region for an opposing player in the battle. Further, on a boundary between the first player region 40 and the second player region 41, operation information 42, which is information of a currently available operation, is displayed.

Each of the first player region 40 and the second player region 41 includes a hand region 43, a field region 44, a base region 45 and a life region 46. In the hand regions 43, cards (hands) acquired from his or her own deck are arranged. Cards selected by the player from either the hand region 43 or the base region 45 are arranged in the field region 44. The cards in the hand region 43 can be placed in the field region 44 by consuming prescribed costs. Each of the cards arranged in the field region 44 can invoke an action or an effect of the card. In the base regions 45, cards and mana items to be consumed as costs for arranging cards in the field region 44 are arranged. The life region 46 includes a player life region 47 which is a region for the player having a life (HP) and a force life region 48 which is a region for a first object (force) having also a life. In the player life regions 47, a second object corresponding to the player and a value of the life owned by the player are displayed. In the force life region 48, first objects and life values owned by the first objects, are respectively displayed. The first object demonstrates a specific effect in the game. Further, in this example, an image of the buddy is displayed as the second object.

In the battle, a turn of the player A and that of the player B who is an opponent in the battle alternatively come. Each of these turns includes a plurality of phases such as a standby phase, a mana phase (a card usage preparation phase), and a main phase (a battle phase) or the like.

The standby phase comprises a step in which cards drawn from the deck are placed in the hand region 43 or the like. In the mana phase, the player can place his or her cards or mana items in the own base region 45 of the player.

In the main phase, the player can perform a summon of a character, an attack against an opponent (attack), activation of a card effect, and movement of a card, etc. The summon of a character is performed by placing a card in the field region 44 under a condition that a payment is made as a cost therefor.

The attack against an opponent (attack) comprises a plurality of steps such as an attack designating step, a flash timing step, a block designation step, a battle settlement step and the like. In the attack designation step, the own player selects an attack target from the opponent and a force. In the flash timing step, the own player and the opponent player can respectively use a specific card having a special effect. In the block designation step, the opponent player can select whether or not to block the attach made by the own player, by using a card placed in the field region 44 of the second player region 41. In the battle settlement step, the result of the attack is judged, and based on the judgement result, solution processing is performed wherein the card on the attacking side and blocking side is vanished, and a life of the opponent player or that of the force etc. is reduced and so on.

In the activation of a card effect, a special effect of a specific card (for example, a magic card) arranged in the hand region 43 is activated, conditional upon payment of compensation. In addition, regarding the movement of a card, the card is moved between the field region 44 and the base region 45. The player may terminate the battle phase without performing any one of: the summon of a character, the attack against an opponent (attack), the activation of the card effect, the movement of a card and the like.

A turn of the player A team, which comprises such a series of phases, and that of the player B team, who is an opponent in the battle, are alternatively repeated, and a win or loss thereof is determined when the life of either of the players reaches zero or the number of cards of his or her deck reaches zero. The rank of the player, the buddy's empirical value and character information of the buddy etc. (changing ability information) change in accordance with the battle result in the game.

In the above-described example, a normal battle, in which the player A and the player B play the battle against each other, is exemplified, and the buddy of the player A and the buddy of the player B provide advice to the player A and the player B respectively.

A team battle can be played by using ability of the second game element (buddy) who can perform an autonomous or voluntary action (use of a card). For example, the player A and the buddy thereof build a team and the player B and the buddy thereof build a team. The team battle includes a first battle, in which the player A and the buddy of the player B play the game against each other, so that a win or loss is determined, and a second battle, in which the player B and the buddy of the player A play the game against each other, so that a win or loss is determined. In addition, in such a team battle, a deck used by each player or the buddy thereof is set from decks the player owns. The set deck of the player may be the same as that of the buddy of the player or may be different from that of the buddy of the player.

### [Functional Configuration]

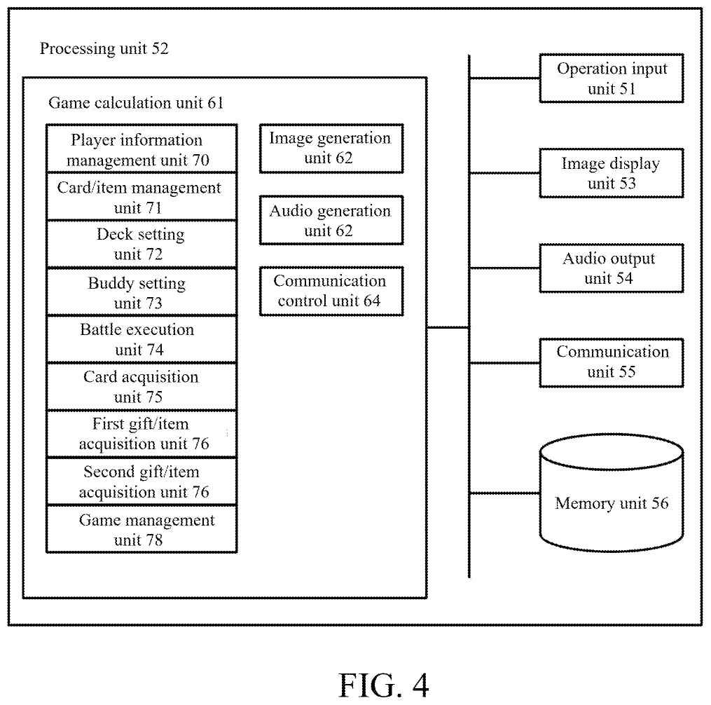

FIG. 4 is a block diagram illustrating a functional configuration of the player terminal 1.

As illustrated in FIG. 4, the player terminal 1 includes an operation input unit 51, a processing unit 52, an image display unit 53, an audio output unit 54, a communication unit 55 and a memory unit 56.

The operation input unit 51 is provided to receive various operation inputs relating to the game, and outputs, to the processing unit 52, an operation input signal which corresponds to the operation inputs. Functions of the operation input unit 51 can be achieved by an element directly manipulated by a finger of the player A, such as a touch operation pad, a home button, a button switch, a joystick, a trackball, etc. Functions of the operation input unit 51 can also be achieved by an element, which detects motion or posture, such as an acceleration sensor, an angular velocity sensor, an inclination sensor, and a geomagnetic sensor, etc. The touch operation panel 12 shown in FIG. 2 corresponds to this element.

The processing unit 52 integrally controls an operation of the player terminal 1 based on the programs and data stored in the memory unit 56 and the operation input signal from the operation input unit 51 or the like. Functions of the processing unit 52 can be achieved, for example, by a microprocessor, such as a CPU, a GPU, etc., and electronic components such as an ASIC and an IC memory etc. The processing unit 52 includes, as main functional units, a game calculating unit 61, an image generation unit 62, and an audio generation unit 63 and a communication control unit 64.

The game calculating unit 61 performs various game processing for realizing a game according to the present embodiment, and outputs a processing result thereof to the image generation unit 62 and the audio generation unit 63. The game calculating unit 61 includes a player information management unit 70, a card item management unit 71, a deck setting unit 72, a buddy setting unit 73, a battle execution unit 74, a card acquisition unit 75, a first gift item acquisition unit 76, a second gift item acquisition unit 77 and a game management unit 78.

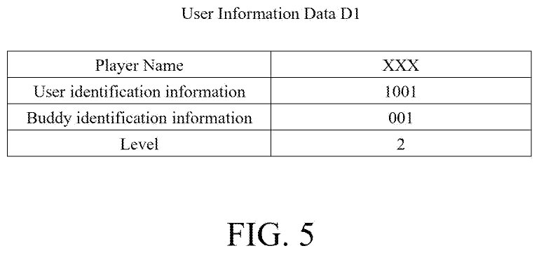

The player information management unit 70 manages player information by using user information data D1. The information to be managed is, for example, basic user information such as player's nickname (player name), user identification information (user ID) within the game etc., identification information of the buddy, a rank of the player, a level of the buddy and the like. FIG. 5 is a diagram illustrating an example of user information data D1.

The card item management unit 71 performs management of cards which can be provided by the game system based on owned card item data D2 and card character data D3, which is stored in the memory unit 56, including management as to whether the player owns the cards and has used them or not.

The in-hand card item data D2 includes a data group in which card identification information of cards which can be provided by the game system, an in-hand flag indicating whether or not the player owns the card, and a use permission flag indicating whether or not the player can use the card, are associated with one another; and a data group in which item identification information of an item which can be provided by the game system and the number of items the player owns, are associated with each other.

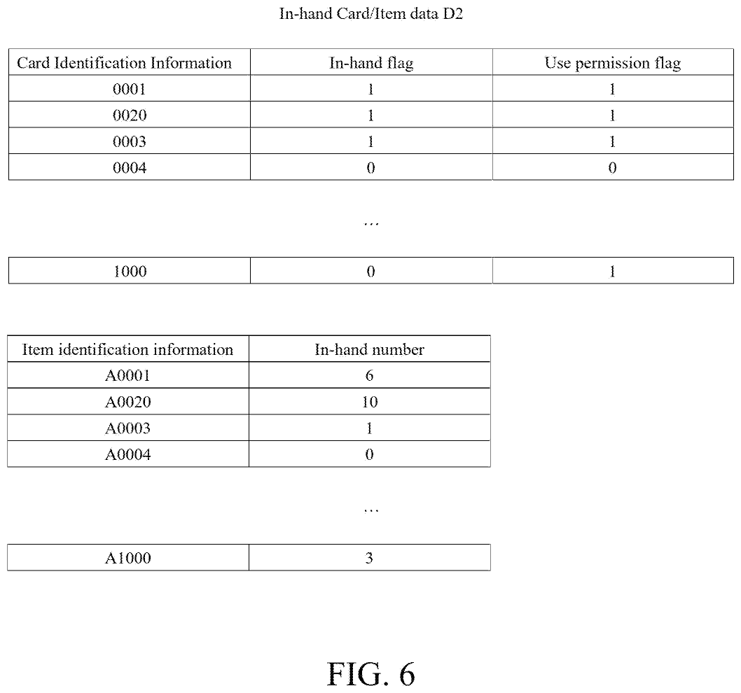

FIG. 6 is a diagram illustrating an example of the in-hand card item data D2. In FIG. 6, card identification information of cards which can be provided by the game system is recorded in the field of the card identification information. And “1” is set to the field of the in-hand flag when the player owns the card corresponding to the card identification information, and “0” is set to the field of the in-hand flag when the player does not own it. In addition, when the player can use the cards in that card identification information, “1” is set to the field of the use permission flag, and when the player cannot use it, “0” is set to the use permission flag. In addition, in the field of the item identification information, item identification information of items which can be provided by the game system. And when the player owns items corresponding to the item identification information, “the number of items” is set to an in-hand number field. FIG. 6 shows an example of the in-hand card item data D2 but it is not limited thereto. In addition, even when “0” is set to the in-hand flag, there are some cases where “1” is set to the field of the use permission flag. For example, even if there is a card the player does not own, the player is temporarily permitted to use the card.

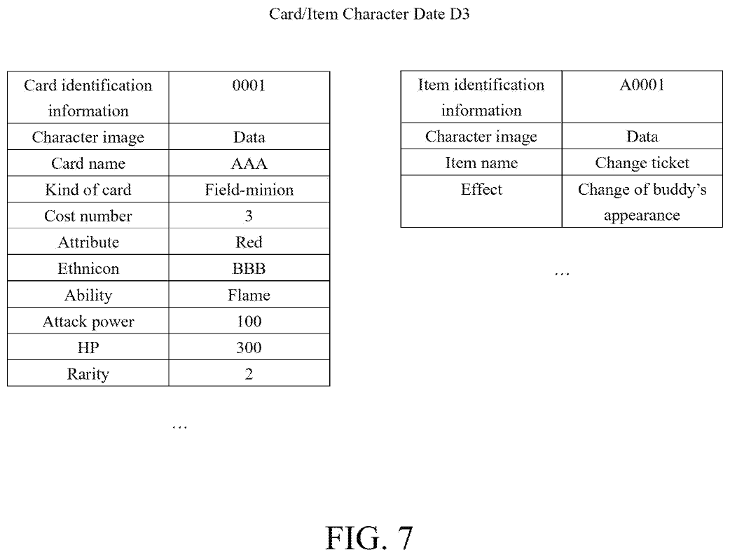

The card item character data D3 includes data in which identification information of cards or items and character information of these cards or items are respectively associated with each other. FIG. 7 is a diagram illustrating an example of the card item character data D3. In FIG. 7, the card identification information and character information (a character image, a card name, the kind of the card, the number of costs, attribute, ethnicon, ability, an attack power, hit point, rarity) are associated with each other. In addition, pieces of the item identification information and pieces of the character information (a character image, an item name, and an effect) are respectively associated with each other. Further, FIG. 7 shows an example of the card item character data D3, but the card item character data D3 is not limited thereto.

When there is a card or item which can be newly provided, the card item management unit 71 acquires identification information of the card or item, and card item character data D3 corresponding to that identification information, through communications with the game server 2. And, the card item management unit 71 additionally adds the acquired card identification information to the in-hand card item data D2, and the in-hand flag of the card identification information is set to “0” and the field of the use permission flag is set to “0”. In addition, the acquired card character data D3 is stored in the memory 56. And when the player newly acquires and owns the card, the card management unit 71 sets the in-hand flag of the card identification information of the in-hand card item data D3 to “1” and sets the field of the use permission flag to “1”. Similarly, the card item management unit 71 additionally stores acquired item identification information in the in-hand card item data D2, and set the number of in-hand items of that item identification information to “0”. In addition, the acquired card item character data D3 is stored in the memory unit 56. And when the player newly acquires and owns an item, the card item management unit 71 sets the in-hand number of the item identification information in the in-hand card item data D3 to the number of in-hand items.

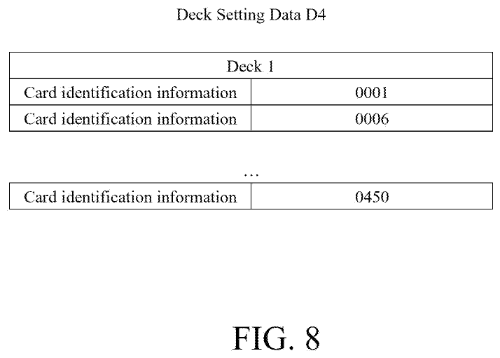

The deck setting unit 72 presents currently-useable cards (basic in-hand card) which can be used as cards forming his or her deck by using the in-hand card item data D2 and the card item character data D3, and selects cards for forming the deck from the presented cards by an operation of the user, whereby the deck is set (composed). The set deck is used in battles by not only the player, but also a buddy of the player. The deck setting unit 72 generates the deck setting data D4 in which a name of the set deck, identification information of the deck (deck ID), and the card identification information of each of the cards which form the deck are associated with one another, and stores it in the memory unit 56. FIG. 8 illustrates an example of the deck setting data D4. FIG. 8 shows an example of the deck setting data D4 of the deck 1 of the player A, wherein the deck 1 having a deck ID “D001” is composed of cards having card identification information “0001”, “0006”, . . . “0450”. Here, FIG. 8 shows an example of the deck setting data D3, and the deck setting data is not limited thereto.

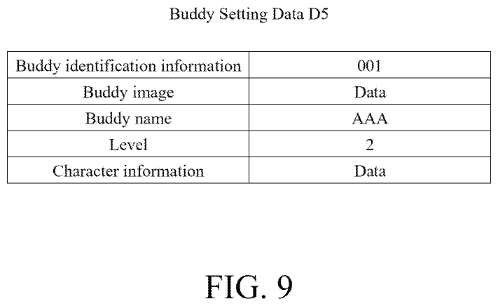

The buddy setting unit 73 manages information relating to buddies selected from a plurality of buddies (second game elements) by the players A and B, using the buddy setting data D4 at account registration. The buddy setting data D4 is character information of the buddies selected by the menu setting. This character information of the buddy changes as the game proceeds, and if it changes, the character information after the change is notified by the game server 2, and the character information is updated. FIG. 9 shows an example of the buddy setting data D5 of the player A. In the example of FIG. 9, each piece of the buddy setting data D5 includes buddy identification information, an image of the buddy, the name of the buddy, a level, character information. FIG. 9 shows an example of the buddy setting data D5, but the buddy setting data D5 is not limited thereto. The level of the buddy (second game element) and the character information thereof is set to an initial value (the lowest value) at time of account registration. In addition, when the buddy is changed, the level of the previous buddy and the character information thereof is not taken over thereby, and the level of the buddy (second game element) and character information thereof after the change is set to an initial value (the lowest value). In addition, the buddy setting unit 73 outputs image information of the buddy to the image generation unit 62 for the menu screen shown during the battle or at some other time.

The battle execution unit 74 performs a normal battle between players and a team battle between teams by using the set decks.

The card acquisition unit 75 performs card acquisition processing for a provision screen (shop screen). Specifically, the card acquisition unit 75 requests a purchase screen of a card desired for acquisition to the game server 2, performs display processing for the purchase screen of the card desired for acquisition, and performs an approval operation of payment of consideration for the acquisition of the card. Here, the consideration is money (actual money, credit card), in-game currency, and a premium ticket (including an in-game ticket). Further, the card acquisition unit 75 outputs card identification information of the acquired card and the like to the card item management unit 71.

In addition, as a card acquisition method, there are (1) a method for acquiring only a desired card, (2) a method in which any card in a series of cards to which the desired card belongs can be acquired but the card the player desires to acquire can be acquired with a predetermined provability, and (3) a method in which a package of a series of cards to which the desired card belongs (aggregate of two or more series of cards to which the desired card belongs) is acquired but the card the player desires to acquire is included in the package with a predetermined probability.

The first gift item acquisition unit 76 acquires a first gift item with a predetermined probability every time the card acquisition unit 75 acquires a card. Here, the first gift item is provided without cost from the game server 2, for example, in-game currency for acquiring cards or buddies, and is a thicket exchangeable for a card or buddy, a ticket for making the appearance of a card or buddy (expression form) changeable. The first gift item acquisition unit 76 performs arithmetic processing for a drawing before the first gift item is acquired, and gives notice of acquisition when the first gift item is acquired, or gives notice of non-acquisition when the first gift item is not acquired. The first gift item acquisition unit 76 transmits item identification of the acquired first gift item to the card item management unit 71.

The second gift item acquisition unit 77 acquires a second gift item provided without cost from the game server 2 when the number of acquisition times of a card or package acquired by the card acquisition unit 75 reaches a predetermined number. Here, the second gift item is similar to the first gift item, for example, in-game currency for acquiring cards or buddies, a thicket exchangeable for a card or buddy, a ticket for making the appearance of a card or buddy (expression form) changeable. In addition, the first gift item may be the same as or different from the second gift item. The second gift item acquisition unit 77 performs arithmetic processing for giving a notice that the number of acquisition times of the acquired card or package reaches a predetermined number and that the second gift item can be acquired before the second gift item is acquired. In addition, the second gift item acquisition unit 77 transmits item identification information of the acquired second gift item to the card item management unit 71.

The game management unit 78 manages a progress of the entire game.

The image generation unit 62 generates one game image screen per one frame time (for example, 1/60 second) based on a processing result of the game calculation unit 61, and outputs the generated image signal for the game screen to the image displaying unit 103. Functions of the image generation unit 63 can be realized by, for example, a processor, such as a GPU, digital signal processor (DSP) etc., a video signal IC, a program for video codec etc., an IC memory for drawing frames such as a frame buffer etc., and an IC memory which is used for texture data development and the like.

Based on the processing result of the game calculating unit 61, the audio generation unit 63 generates audio signals for sound effects and BGM, audio information of operation assistance information, and various operation sounds or the like, which are related to the game, and outputs these audio signals to the audio output unit 54. Functions of the audio control unit 64 can be realized by, for example, a processor such as a digital signal processor (DSP), an audio synthesis IC, etc., and an audio codec capable of reproducing an audio file and the like.

The communication control unit 64 performs communication connection and data processing for data communication with the game server 2.

The image display unit 53 displays various game screens based on an image signal(s), which is input from the image generation unit 63. For example, functions of the image display unit 53 can be realized by a display device, such as a flat panel display, a cathode ray tube (CRT), a projector, a head-mounted display, etc. In FIG. 2, the image display unit 53 corresponds to the display 11.

The audio output unit 54 outputs sounds such as sound effects or the like, which are related to the game, based on an audio signal inputted from the audio generation unit 64. In FIG. 2, the audio output unit 54 corresponds to the speaker 13.

The communication unit 55 achieves communication by connecting with the communication line N. Functions of the communication unit 55 can be realized by, for example, a wireless communication device, a modem, a TA (terminal adapter), a jack and a control circuit of a communication cable for wired communication, and the like.

In the memory unit 56, programs for causing the player terminal 1 to perform operations and for realizing various functions provided in the player terminal 1, and data etc. used during running of the programs are stored in advance, or such programs and data are temporarily stored every time each processing is performed. The memory unit 56 can be realized by, for example, an IC memory, such as a RAM, a ROM, a flash memory, etc., a magnetic disk such as a hard disk, etc., or an optical disc, such as a CD-ROM, a DVD, etc.

In the memory unit 56, a system program and a game program are stored. The system program realizes a basic function of the player terminal 1 as a computer. The game program causes the processing unit 52 to function as a game calculating unit 61. This program is distributed from the game server 2 or some other application distribution server or the like when an account of the player is registered.

Further, the user information data D1, the in-hand card item data D2, the card item character data D3, deck setting data D4, and the buddy setting data D5 is stored in the memory unit 56. In addition, model data and texture data for displaying images of card characters and a buddy, motion data, effect data, background images of game screens, sound data such as sound effects, etc. is accordingly distributed as data needed for the game and is stored in the memory unit 56.

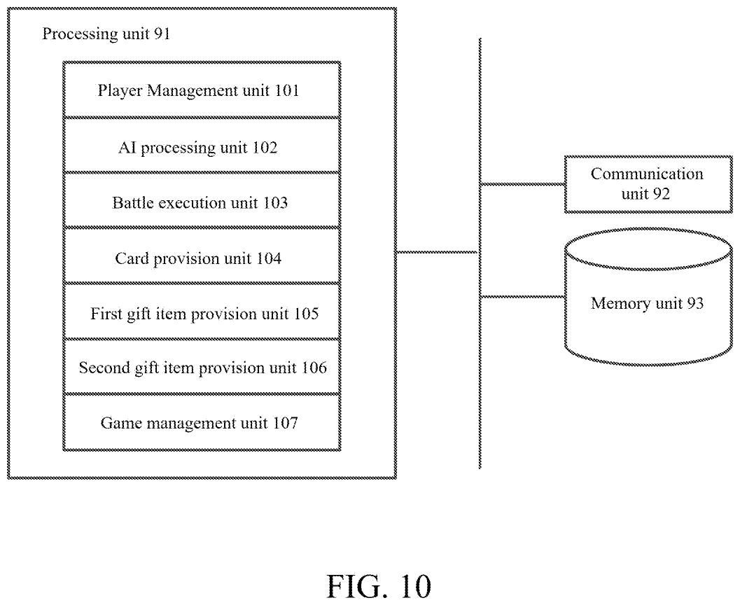

Next, description of the configuration of the game server 2 will be given. FIG. 10 is a block diagram illustrating an example of a functional configuration of the game server 2.

The game server 2 includes a processing unit 91, a communication unit 92 and a memory unit 93.

The processing unit 91 includes a player management unit 101, an AI processing unit 102, a battle execution unit 103, a card provision unit 104, a first gift item provision unit 105, a second gift item provision unit 106, and a game management unit 107.

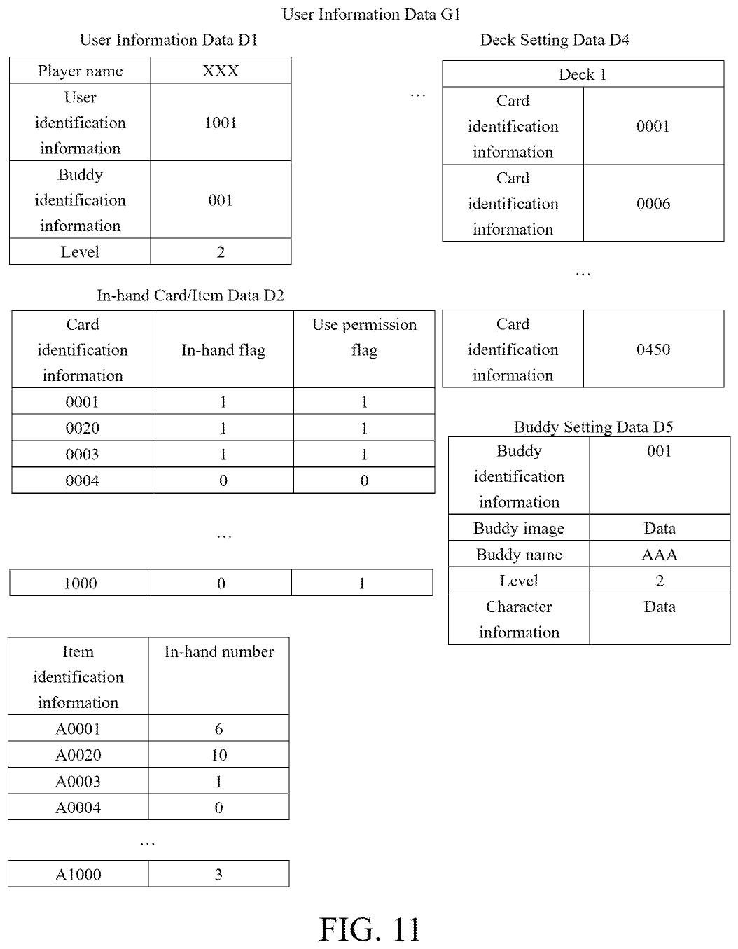

The player management unit 101 manages accounts and the state of progress etc. of the game by using the user information data G1, for each of players of the player terminals 1. The user information data G1 is basic data of players who take part in the game, and the user information data G1 is stored for each player. FIG. 11 is a diagram illustrating an example of user information data G1. In the example of FIG. 11, the user information data G1 includes user identification information D1 of a player, in-hand card item data D2, deck setting data D4 and buddy setting data D5. In addition, FIG. 11 shows an example of the user information data G1, but the user information data G1 is not limited thereto.

The AI processing unit 102 has a learning model obtained by performing machine learning, which uses training data such as details of progress of many battle games and results thereof etc. The output contents of the learning model are different from each other, depending on the character information of the buddy (buddy's ability). As an example of such a learning model, the higher the character information level of the buddy (buddy's ability) is, the search time for the optimal solution is made longer, so that the more appropriate solution than that in a certain situation can be obtained, as the level of the character information of the buddy (buddy's ability) is higher. Although deep learning (deep machine learning) is representative of a method of the machine learning, it is not limited thereto. The AI processing unit 102 receives the card setting information and, character information of the buddy for the player of the terminal 1, which is transmitted from the player terminal 1, and outputs operation assistance information (advice information) of the card setting information in that situation or card operation information of the buddy. The card operation information includes information of a movement of a card, an attack target, defending methods and the like. In the algorithm, since the content of the card operation information differs depending on the character information of the buddies, even if pieces of the card setting information transmitted from the player terminal 1 are the same as each other in different situations, when pieces of the character information of buddies are different from each other, there is a possibility that pieces of the operation assistance information (advice information) or card operation information are different from each other.

The battle execution unit 103 performs not only a player v. player battle but also a battle between a player and a buddy (non-player) by receiving an output from the AI processing unit 102.

The card provision unit 104 provides players with cards, and provides a function called a shop. In particular, the card provision unit 104 transmits a provision screen (for example, a top screen of the shop) to the player terminal 1 in response to a card provision request from the player terminal 1.

As methods for providing a card as the shop by the card provision unit 104, there are (1) a method for providing only a desired card, (2) a method in which any card in a series of cards to which the desired card belongs can be provided but the card the player desires to acquire can be acquired with a predetermined provability, and (3) a method in which a package of series to which the desired card belongs (aggregate of two or more series of cards to which the desired card belongs) can be provided but the card the player desires to acquire is included in the package with a predetermined probability. In the memory unit 93, acquisition provability of each card, card identification information of cards which form each package, an acquisition price of each card etc. are stored. The card provision unit 104 provides the player terminal 1 with the card identification information of the card to be provided by using these pieces of information. In addition, the card provision unit 104 makes payment (actual money, in-game currency and ticket) for acquiring cards.

Every time the card provision unit 104 provides a card or package, the first gift item provision unit 105 performs, with a predetermined provability, drawing processing as to whether or not to provide a first gift item. When the first gift item can be provided (win) as a result of the drawing processing, the item identification information of the item is transmitted to the player terminal 1, thereby providing the first gift item. Here, the first gift item is given to the player without cost from the game server 2, for example, in-game currency for acquiring cards or buddies, a ticket which is exchangeable for a card or buddy, a ticket which makes the appearance (expression form) of the card or buddy changeable, or the like.

The predetermined provability may be generated in a random manner, every time a card or package is provided, without regard to the number of card or package provision times. The provision provability may be increased in accordance with the number of card or package provision times (make it easier to provide them). In addition, the predetermined provability may be a provability with which a first gift item is provided at least once during a time when the number of the card or package provision times is equal to or smaller than the predetermined target number of provision times. In addition, description of the predetermined target number of provision times will be given later.

The second gift item provision unit 106 transmits the item identification information to the player terminal 1 thereby providing the second gift item, when the number of the card or package provision times of the card provision unit 104 reaches the target provision number. Here, the target provision number is a value set by the game administration side, and the target number of times at which the second gift items can be provided. For example, in case where the target number of provision times is set to 100, when the number of provision times of cards or packages provided by the card provision unit 104 reaches 100, the second gift item provision unit 106 provides a second girt item. The second gift item provision unit 106 is different from the first gift item provision unit 105, in that an item is not provided by a drawing with a predetermined provability, but the second gift item is provided based on the predetermined number of card or package provision times. Here, the second gift item is provided to the player without cost from the game server 2, for example, in-game currency for acquiring cards or buddies, a ticket which is exchangeable for a card or buddy, a ticket which makes the appearance (expression form) of a card or buddy changeable, or the like. Kinds of the second gift items to be provided may be the same as or different from those of the first gift items.

The game management unit 107 manages the entire game.

The communication unit 92 achieves communication by connecting with the communication line N.

In the memory unit 93, a system program and a game program are stored. The system program realizes a basic function of the game server 2 as a computer. The game program causes the processing unit 91 to function as the player management unit 101, the AI processing unit 102, the battle execution unit 103, the card provision unit 104, the first gift item provision unit 105, the second gift item provision unit 106, and the game management unit 107.

Further, the user information data G1 and card data is stored in the memory unit 92.

The card data includes data for all the cards used in the present game. Data which is basically similar to the above-described card item character data D3, is stored therein for all the cards and items used in the game. In addition, the card data may include basic data for a buddy (buddy identification information, a character image, a buddy name, an initial value of the level, an initial value of a card comprehension level, an initial value of personality, and an initial value of a synchronization level), which is used in the present game.

[An Operation of Each Device]

Next, operations of the player terminal 1 and the game server 2 will be described. In the description set forth below, the game server 2 provides one card package in response to a request for one card package from the player terminal 1. And in the example described below, the target number of second gift item provision times is set to 100, and the first gift item provision provability is set so that a first gift item can be provided at least once during a time when the number of provision times is equal to or smaller than the target number of provision times. In addition, in the example described below, each of the first gift item and the second gift item is a change ticket which can change the appearance of the buddy.

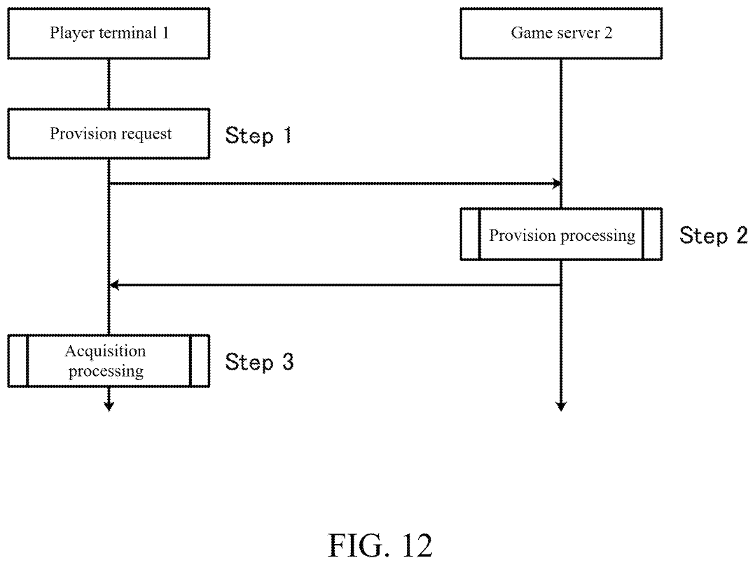

First, a sequence between the player terminal 1 and the game server 2 will be described. FIG. 12 is a sequence diagram illustrating operations of the player terminal 1 and the game server 2.

The player requests provision of a card package by using the player terminal 1 (Step 1). The game server 2 performs provision processing in response to the provision request from the player terminal 1 (Step 2). The player terminal 1 performs processing for acquiring the provided card package, first gift item or second gift item (Step 3). Such processing is performed for each provision of the card package until the target number of provision times is reached.

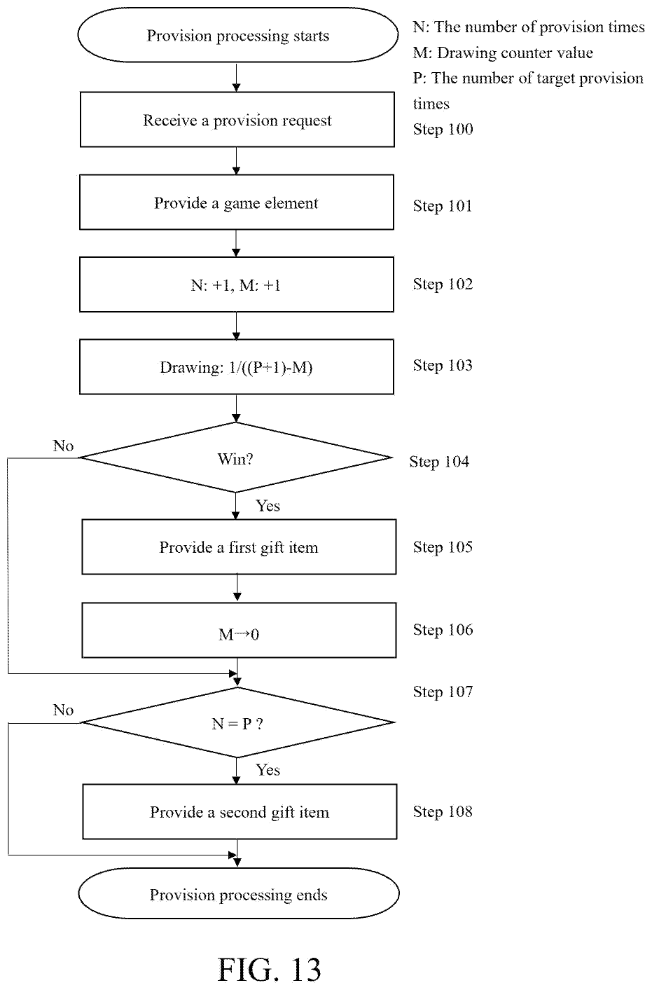

Next, description of the provision processing (Step 2) performed in the game server 2 will be given. FIG. 13 is a flowchart illustrating the provision processing performed in the game server 2 (Step 2). In the description set forth below, the number of provision times where the game server 2 provides a card package is N; the number of times of processing for a provision drawing of a second gift item, which is performed every time the card package is provided, is M; and the target number of second item provision times is P.

When the card provision unit 104 of the game server 2 receives a request for provision of one card package (Step 100), the card provision unit 104 provides the card package (game element) to the player terminal 1 (Step 101). The provision of the card package is performed by transmitting card identification information of cards included in the one card package.

When the card provision unit 104 provides the one card package to the player terminal 1, the first gift item provision unit 105 increments a drawing counter value M by 1, and the second gift item provision unit 106 increments the provision number N by 1 (Step 102).

Subsequently, the first gift item provision unit 105 performs drawing processing for determining whether a first gift item is provided with a predetermined drawing provability (Step 103). Here, the drawing provability is expressed by 1/((P+1)−M). This provability is a provability with which a first gift item can be provided at least once during a period where the number of card package provision times is equal to or smaller than the target number of provision times P (100 times). For example, when the target value P is 100 times, the provability is expressed by 1/((100+1)−100)=1 at least when the provision time is the 100th time, so that a first gift item is always provided when the provision time is the 100th time.

As a result of the drawing with a predetermined provability (Step 104), the first item provision unit 105 provides the first gift item in case of a win (Step 105). The first gift item is provided by transmitting item identification information of the first gift item. In this example, since a change ticket which can change the appearance of a buddy, is provided as the first gift item, item identification information of the change ticket is transmitted.

The first gift item provision unit 105 resets the drawing counter value M to 0 (Step 106). This reset of the drawing counter value M is performed to prevent the winning probability from wastefully increasing since the first gift item can be provided at least once until the target number of provision times P is reached. On the other hand, if not won, the processing proceeds to Step 107.

Next, the second gift item provision unit 106 determines whether the number of the provision times N is equal to the target number of the provision times P (Step 107). When the number of the provision times N is equal to the target number of provision times P (100 times), the second gift item provision unit 106 provides a second gift item (Step 108). The second gift item is provided by transmitting item identification information of the second gift item. In this example, when the number of the provision times N reaches 100, since a change ticket which can change the appearance of the buddy is provided as the second gift item, item identification information of the change ticket is transmitted. And, the provision processing ends. On the other hand, when the number of the provision times N is smaller than the target number of the provision times P, the provision processing ends.

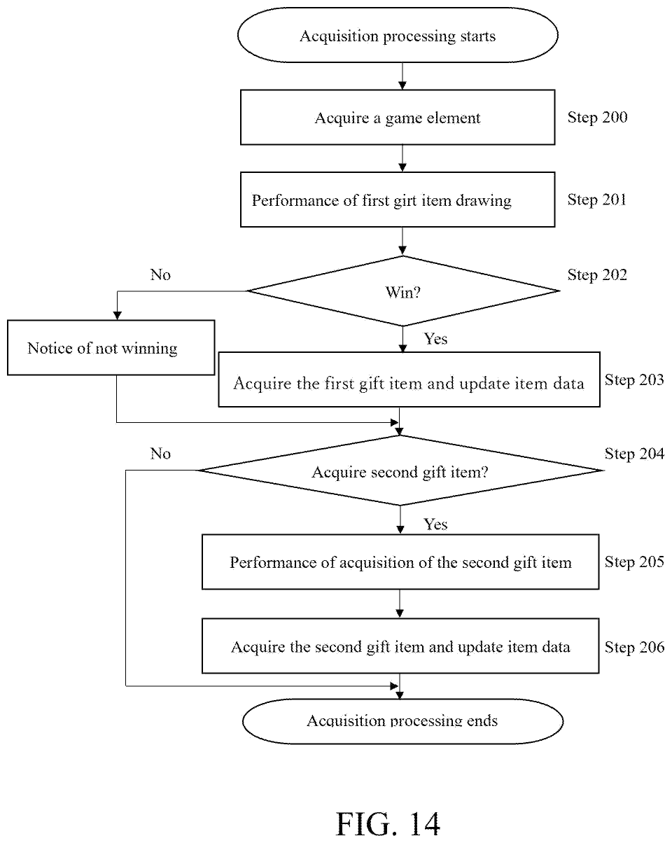

Subsequently, the acquisition processing performed by the player terminal 1 (Step 3) is described. FIG. 14 is a flowchart illustrating the acquisition processing performed by the player terminal 1 (Step 3).

The card acquisition unit 75 of the player terminal 1 acquires the card package provided from the game server 2 (Step 200). The card acquisition unit 75 transmits card identification information included in the provided card package to the card item management unit 71. The card item management unit 71 sets “1” to the in-hand flag corresponding to the received card identification information among pieces of the in-hand card item data D1.

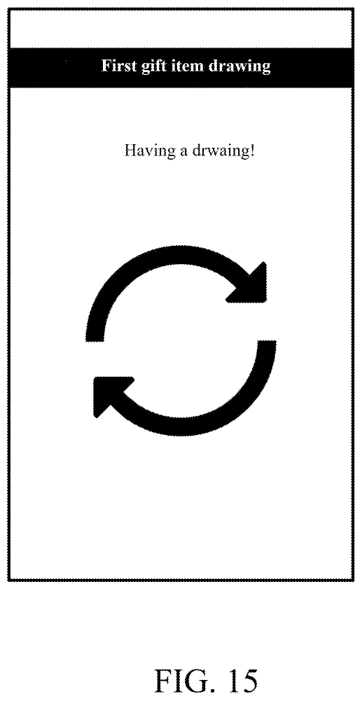

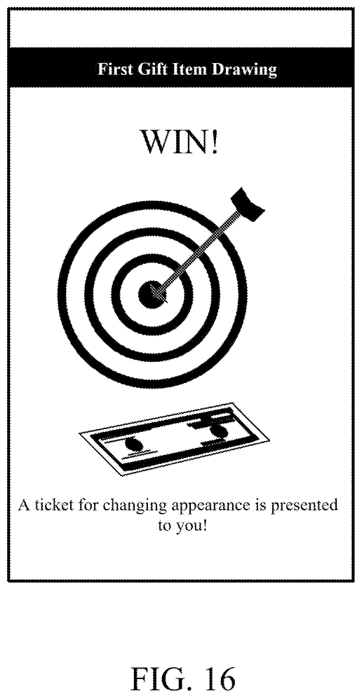

The first gift item acquisition unit 76 performs performance processing for the drawing of the first gift item (Step 201). FIG. 15 shows an example of a performance screen for the drawing of the first gift item shown on the player terminal 1. When the performance processing ends and the first gift item is won (Step 202), item identification information of the first gift item is acquired from the game server 2. FIG. 16 is an example of the performance screen displayed on the player terminal 1 in case where the first gift item is won. And the card item management unit 71 updates the in-hand card item data D2 by using the item identification information of the first gift item acquired by the first gift item acquisition unit 75 (Step 203). In the present example, since the first gift item acquisition unit 76 acquires the change ticket which can change the appearance of the buddy as the first gift item, the card item management unit 71 updates the in-hand card item data D2 corresponding to the item identification information of the received change ticket.

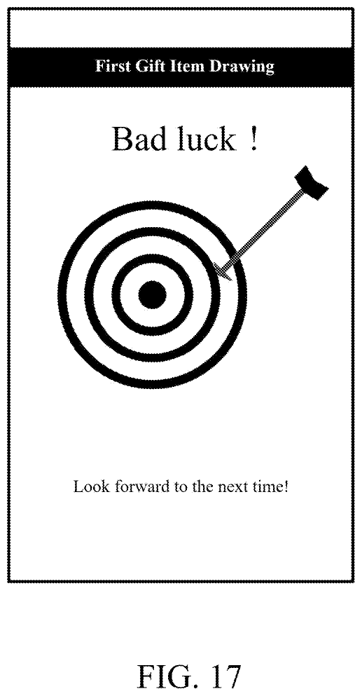

On the other hand, when the first gift item is not won (Step 202), performance processing for non-winning is performed (Step 207). FIG. 17 shows an example of the performance screen displayed on the player terminal 1 when the first gift item is not won.

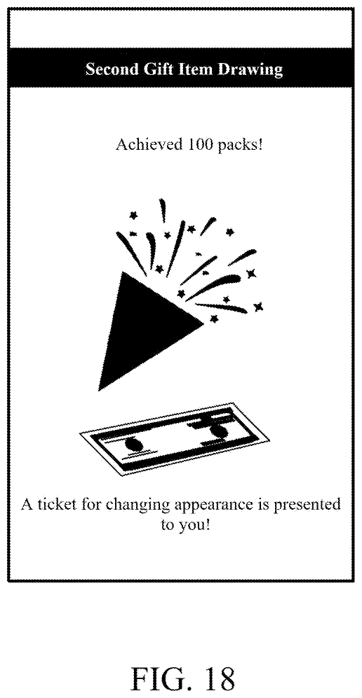

Subsequently, the second gift item acquisition unit 77 determines whether the second gift item is provided from the game server 2 (Step 204). When the second gift item is provided, performance processing for acquiring the second gift item is performed (Step 205). FIG. 18 shows an example of a performance screen for acquisition of the second gift item, which is displayed on the player terminal 1. After the performance of the second gift item acquisition is done, the card item management unit 71 updates the in-hand card item data D2 by using item identification information of the second gift item acquired by the second gift item acquisition unit 77 (Step 206). In the present example, since the second gift item acquisition unit 77 acquires the change ticket which can change the appearance of the buddy as the second gift item, the card item management unit 71 updates the in-hand card item data D2 corresponding to the item identification information of the received change ticket.

On the other hand, the second gift item acquisition unit 77 ends processing when the second gift item is not provided from the game server 2.

In the present embodiment, there is a possibility that an item can be acquired every time a care or package is acquired, and further when the number of card or package acquisition times reaches a predetermined number of times, such an item can be acquired. In such a configuration, since the player can experience accidentality of item acquisition and certainty of the item acquisition at the same time, interest of the player can be maintained without losing his or her interest in acquisition of card or package.

Further, since the drawing provability of the first gift item provision unit 105 is set so that the first gift item can be provided at least once during a period when the number of card or package provision times is equal to or smaller than the target number of provision times, the player can acquire an item at least once or more in a drawing performed every time the card or package is provided, and further since the player can acquire an item when the number of card or package provision times reaches the predetermined number of times, it is possible to realize an item provision which makes the player feel beneficial.

<Modified Example of the Embodiment According to the Present Invention>

In the configuration according to the above-described embodiment, there is a possibility that a player acquires an item every time a card or package is acquired, and an item can be acquired when the number of card or package acquisition times reaches the predetermined number of times. In other word, at a time when the number of card or package acquisition times reaches the predetermined number of times, the player can acquire at least one item.

Accordingly, if it is considered that an object is accomplished where the player has acquired at least one item at time when the number of card or package acquisition times reaches the predetermined number of times, an operation of the second gift item provision unit 106 can be omitted if the above-mentioned drawing provability of the first gift item provision unit 105 is set so that a first gift item can be provided at least once during a period where the number of card or package provision times is equal to or smaller than the target number of provision times.

In addition, the drawing provability of the first gift item provision unit 105 need not be set in such a way. That is, the second provision unit 106 determines whether or not the first gift item provision unit 105 provides the player with an item even once at time when the number of card or package provision times reaches the target number of provision times, and if the item has been provided to the player even once, an item will not be provided.

The modified example of the embodiment according to the present invention is effective at preventing excessive items from being provided to the player.

Although in the above-described embodiments, a card game in which virtual game cards are used, is exemplified, the applicable game is not limited to such a category. For example, it may be a match-up game of sports in which characters associated with first game elements are players, or a raising game of a character associated with a first game element.

In addition, part or all of the above-described embodiments can be also described as in additional remarks set forth below. However, the present invention is not limited thereto.

[Additional Remark 1]

A terminal which causes a computer to execute a battle game in which a game element is used by a player, comprises a memory in which an execution instruction is stored, and a processor, wherein, based on the executive instruction, the processor performs game element acquisition processing for acquiring the game element, first gift item acquisition processing in which a first gift item can be acquired every time the game element is acquired, and second gift item acquisition processing in which a second gift item can be acquired when the number of game element acquisition times reaches a predetermined value.

[Additional Remark 2]

A game management device which manages a game performed by a player using a game element, comprises a memory in which an execution instruction is stored, and a processor, wherein, based on the executive instruction, the processor performs game element provision processing for providing the game element, first gift item provision processing in which a first gift item can be provided every time the game element is provided, and second gift item provision processing in which a second gift item can be provided when the number of game element provision times reaches a predetermined value.

As described above, although the preferred embodiments are exemplified to explain the present invention, the present invention is not necessarily limited to the above-described embodiments, and can be modified and practiced in various manners within a technical idea of the present invention.

### REFERENCE SIGNS LIST

1 Player terminal
2 Game server
11 Display
12 Touch operation panel
13 Speaker
51 Operation input unit
52 Processing unit
53 Image display unit
54 Audio output unit
55 Communication unit
56 Memory unit
61 Game calculation unit
62 Image generation unit
63 Audio generation unit
64 Communication control unit
70 Player information management unit
71 Card management unit
72 Deck setting unit
73 Buddy setting unit
74 Battle execution unit
75 Card acquisition unit
76 First gift item acquisition unit
77 Second gift item acquisition unit
78 Game management unit
91 Processing unit
92 Communication unit
93 Memory unit
101 Player management unit
102 AI processing unit
103 Battle execution unit
104 Card provision unit
105 First gift item provision unit
106 Second gift item provision unit
107 Game management unit

1. A program, which causes a computer to function as a game element acquisition unit configured to acquire a game element, a first gift item acquisition unit capable of acquiring a first gift item every time the game element is acquired, and a second gift item acquisition unit capable of acquiring a second gift item when a number of game element acquisition times reaches a predetermined value.

2. The program according to claim 1, wherein the first gift item acquisition unit acquires the first gift item with a predetermined provability every time the game element is acquired.

3. The program according to claim 1, wherein the first gift item acquisition unit acquires the first gift item at least once while the number of the game element acquisition times is equal to or smaller than the predetermined value.

4. The program according to claim 1, wherein the second gift item acquisition unit does not acquire the second gift item when the first gift item acquisition unit acquires the first gift item.

5. The program according to claim 1, wherein the second gift item acquisition unit acquires the game element after performance of acquisition of the game element.

6. The program according to claim 1, wherein the first gift item and the second gift item are the same as or similar to the game element, or an item capable of changing an appearance of the game element, an item exchangeable for the game element, or in-game currency.

7. The program according to claim 1, wherein the game element acquisition unit acquires a single game element or aggregate of a plurality of game elements at one time acquisition.

8. A terminal comprising:
a game element acquisition unit configured to acquire a game item;
a first gift acquisition unit capable of acquiring a first gift item every time the game element is acquired; and
a second gift item acquisition unit capable of acquiring a second gift item when a number of game element acquisition times reaches a predetermined value.

9. (canceled)

10. A game management apparatus comprising:
a game element provision unit configured to provide a game element;
a first gift item provision unit capable of providing a first gift item every time the game element is provided; and
a second gift item provision unit capable of providing a second gift item when a number of provision times of the game element reaches a predetermined value.

11. The game management apparatus according to claim 10, wherein the first gift item provision unit provides the first gift item with a predetermined probability every time the game element is provided.

12. The game management apparatus according to claim 10, wherein the first gift item provision unit provides the first gift item at least once while the number of game element provision times is equal to or smaller than the predetermined value.

13. The game management apparatus according to claim 10, wherein the second gift item provision unit does not provide the second gift item when the first gift item provision unit provides the first girt item.

14. The game management apparatus according to claim 10, wherein the first gift item and the second gift item are the same as or similar to the game element, or an item capable of changing an appearance of the game element, an item exchangeable for the game element, or in-game currency.

15. The game management apparatus according to 10, wherein the game element providing unit provides a single game element or aggregate of a plurality of game elements at one time provision.

16. (canceled)
